(19) United States
(12) Patent Application Publication
(10) Pub. No.: US 2009/0145130 A1
(43) Pub. Date: Jun. 11, 2009

(54) Building energy recovery, storage and supply system

(76) Inventor: Jay Stephen Kaufman, Kingston, NH (US)

Correspondence Address: Lawson & Persson, P.C., P.O. Box 712, Laconia, NH, 03247-0712, US

(21) Appl. No.: 12/315,002

(22) Filed: Nov. 26, 2008

Related U.S. Application Data
(63) Continuation-in-part of application No. 11/194,822, filed on Aug. 1, 2005.
(60) Provisional application No. 60/602,949, filed on Aug. 20, 2004.

(51) Int. Cl. F02C 1/00

(52) U.S. Cl. 60/722

(57) ABSTRACT

A building having an energy conversion apparatus and method for distributed energy systems using recovered energy of stationary structure wind resistance and solar radiation in conjunction with normal and off-peak operation of a gas turbine engine. The energy sources are combined, as available, for electric generation and to drive an air liquefier. Liquid air compression and pre-compression cooling of an atmospheric air portion of engine working fluid reduces compression work while increasing engine efficiency. The liquefied air is stored and transferred between buildings and between buildings and vehicles, as required.

### CROSS REFERENCE TO RELATED APPLICATIONS

This application is a continuation-in-part application of co-pending U.S. patent application Ser. No. 11/194,822, filed on Aug. 1, 2005, which claims the benefit of priority of Provisional Application Ser. No. 60/602,949, filed Aug. 20, 2004.

### BACKGROUND

This invention presents a unique energy recovery and storage system for providing solar, wind and other available energy to a building in conjunction with a cryogenic compression cooled gas turbine. Supplementary liquid air coolant is imported while excess liquid air is exported for use by vehicles and other buildings.

Economical on-site generation of power in conjunction with renewable sources has long been a goal of building design to provide energy independence, conserve fossil fuels, and to reduce emission of combustion products. Several concepts are described in the prior art using solar energy, free wind energy or wind dissipated by a structure to provide power to buildings. These systems are inefficient and provide inadequate storage for the intermittent energy recovery. The prior art also describes constant load gas turbine operation with liquid air cooling, but for high fuel consumption grid-connected central station use. With the exception of storage and transfer of electrical energy between buildings and vehicles, the prior art does not describe combined and coordinated systems for both instant and reserve use.

As described below, a number of building energy recovery systems have been developed and patented. However, each of these systems has significant disadvantages.

U.S. Pat. No. 6,765,309, issued to Tallal et. al., describes a fixed wind turbine ducted to the rear of a building for recovery of wind impact on roof tops. However, this system is highly inefficient due to its reliance upon extensive ducting, as duct friction and low suction behind the building create a weak differential pressure. Further, this system requires all power generated to be stored in batteries, which have low capacity per unit mass and recharge relatively slowly.

U.S. Pat. No. 3,956,902, issued to Fields, describes a windmill for supplementing energy to a building. The windmill recovers free wind, which is inefficient due to weak suction. Therefore, this system is insufficient to meet building power requirement. Further, this system also requires all power generated to be stored in batteries.

U.S. Pat. No. 4,229,941, issued to Hope, describes electric generation using combined solar and free wind energy sources. Wind recovery is inefficient due to weak suction. Further, this system also requires all power generated to be stored in batteries.

U.S. Pat. No. 4,455,834, issued to Earle, describes a windmill with a compressed air storage system for providing energy to a building. The windmill recovers free wind, which is inefficient due to weak suction and, consequently, is insufficient to meet building power requirements. In addition, no cooling is provided for the air liquefier.

Other patents have shown the use of liquefied air in connection with power generation. However, these systems also have significant drawbacks. For example, U.S. Pat. No. 4,227,374, issued to Oxley, describes a method for storage of excess energy produced by renewable sources or by a central power station. The energy is used to liquefy atmospheric nitrogen and oxygen, which is stored at cryogenic temperature and used, in combination with a heat source, for powering a heat engine. However, this system does not use the liquefied gases effectively to provide engine compression cooling and supplementary recovered energy and transfer of liquefied gases is not considered.

Finally, U.S. Pat. No. 6,920,759, issued to Wakana et. al., describes a liquid air cooled constant load gas turbine for central power station use. Liquid air normally provides engine compression cooling to minimize compression work and the engine drives an air liquefier during off-peak operation to make-up coolant. However, this system also does not use the liquefied gases effectively to provide engine compression cooling and supplementary recovered energy. In addition, the transfer of liquefied gases is not considered.

Therefore, there is a need for an energy recovery system for distributed energy application that recovers wind energy dissipated by stationary structures that has adequate suction to provide efficient operation that meet building power requirements, that does not require extensive ducting and its associated losses, creates a liquefied gas from the energy generated thereby, effectively uses the liquefied gases to provide engine compression cooling and supplementary recovered energy, and allows for the transfer of liquefied gases for other uses, such as vehicle use.

### SUMMARY

The present invention is a building that includes an energy recovery system, and a building that includes an energy recovery system and an energy storage and supply system.

In a preferred embodiment, the building includes a building structure and an energy recovery system. The building has least a front wall and a roof forming a roof junction with the front wall. The energy recovery system includes at least one wind drive mounted to the building structure proximate to the roof junction between the roof and the front wall. The wind drive includes a housing including an open front portion and a rear portion. A wind turbine is disposed proximate to the front portion of the housing in substantially parallel relation to the front wall. A generator is in mechanical communication with the wind turbine and an electrical output is in electrical communication with the generator. An outlet is disposed behind the wind turbine and the generator and in non-parallel, preferably perpendicular, relation to the wind turbine. The outlet may be a substantially circular duct or simply an opening in the housing. Finally, the roof includes an opening therethrough, the outlet of the wind drive is in communication with the opening, and the opening and the outlet are disposed within a wake region behind the roof junction.

A preferred building also including a side wall forming a wall junction with the front wall. In these embodiments, at least one wind drive is mounted to the building structure proximate to the roof junction between the roof and the front wall and the wall junction between the front wall and the side wall. In other embodiments, the wind drive is not mounted proximate to the roof junction but, rather is mounted along the wall junction between the side wall and front wall.

In some embodiments of the building, a second structure, such as a fence, is disposed proximate to the building. The second structure includes at least two surfaces and a junction between the at least two surfaces, and the energy recovery system also includes at least one wind drive mounted to the second structure proximate to the junction between the two surfaces.

The preferred energy recovery system also includes at least one photovoltaic panel disposed upon the roof of the building.

The preferred building also including an energy storage and supply system. This system includes at least one compressor in fluid communication with at least one source of air, a combustor in fluid communication with the at least one compressor, a source of fuel in fluid communication with the combustor, a gas turbine in fluid communication with the combustor and in mechanical communication with a rotatable shaft, and a turbine generator in mechanical communication with, and driven by, the rotatable shaft. The turbine generator includes an electrical output, which preferably supplies power to a power conditioner in electrical communication with the electrical output of the wind drive and the electrical output of the turbine generator. The power conditioner provides power to the liquid air supply system and exports excess power for use by the building or for sale to the power grid.

The preferred energy storage and supply system includes an air liquefier in electrical communication with the power conditioner and in fluid communication with a source of atmospheric air, a liquid air storage tank in fluid communication with the liquefier and the compressor and a compressed air storage tank disposed between and in fluid communication with the compressor and the combustor. The gas turbine includes an exhaust and the preferred energy storage and supply system also includes a mixing header in communication with the liquid air storage tank and the compressor, a chiller in fluid communication with the compressed air storage tank and the source of atmospheric air for the mixing header, and a recuperator in fluid communication with the chiller and the exhaust of the gas turbine.

It is preferred that the energy storage and supply system include an atmospheric air supply system and a liquid air supply system. The preferred atmospheric air supply system includes an atmospheric air compressor in fluid communication with a source of atmospheric air and the liquid air supply system includes a liquid air compressor in fluid communication with a source of liquid air. The atmospheric air compressor and the liquid air compressor are both preferably in mechanical communication with, and driven by, the rotatable shaft. In embodiments utilizing two air supply systems, it is preferred that the energy storage and supply system include an atmospheric air supply valve in fluid communication with the atmospheric air compressor and a liquid air supply valve in fluid communication with the liquid air compressor. In these embodiments, the power conditioner includes a controller having a signal input and at least two signal outputs, the liquid air storage tank includes a level gage having a signal output in electrical communication with the signal input of the controller, the atmospheric air supply valve and liquid air supply valve each include a signal input in electrical communication with a signal output of the controller, the liquid air supply valve includes a signal output in electrical communication with one of the at least two signal outputs of the controller of the power conditioner. The controller includes control means for accepting a low level signal from the level gage through the signal input, sending a signal to the liquid air supply valve instructing the liquid air supply valve to close, and sending a signal to the atmospheric air supply valve instructing the atmospheric air supply valve to open.

Finally, the preferred energy storage and supply system also including a liquid air inlet, a liquid air pump and a liquid air drain valve in fluid communication with the liquid air storage tank. The liquid air inlet allows liquid air to be added to the system from an external source. The liquid air pump and a liquid air drain valve allow liquid air produced by the system to be exported to another use, such as to operate a liquid air driven vehicle.

Therefore, it is an aspect of the present invention, therefore to provide an energy recovery system for distributed energy application having provision for recovery of wind energy dissipated by stationary structures, recovery of solar energy on stationary structures, recovery of other available energy sources, transfer of liquefied gas between stationary structures and vehicles, and reliquefaction of liquefied gas.

It is another aspect of the present invention to provide a system for combining recovered energy sources available to stationary structures.

It is another aspect of the present invention to provide a storage system to make up the difference between energy requirements of a building and available recovered energy.

In keeping with these aspects and others which may become apparent, the present invention seeks to provide a unified energy system to recover, store, transfer and utilize energy dissipated by a stationary structure or otherwise available thereto.

(a) A feature of the energy system in accordance with the present invention lies in combining wind, solar and other recoverable energy sources of a building and proximate stationary structures, for delivering electrical energy.

(b) Another feature of the energy system in accordance with the present invention lies in providing a reserve gas turbine engine to make up the difference between energy requirements of a building and available recovered energy.

(c) Another feature of the energy system in accordance with the present invention lies in providing an energy recovery system for a building having wind turbine-generators, driven by the difference between impact and wake pressures while discharging to high suction locations behind windward edges of the building or proximate structures, for delivering electrical energy.

(d) Another feature of the energy system in accordance with the present invention lies in providing an energy recovery system for a building having photo-voltaic panels for delivering electrical energy.

(e) Another feature of the energy system in accordance with the present invention lies in providing liquid air compression and pre-compression cooling of a reserve gas turbine engine to reduce engine compression work.

(f) Another feature of the energy system in accordance with the present invention lies in providing an air liquefier, driven by recovered energy or a reserve engine, for liquefaction and reliquefaction of air, vaporized by reserve gas turbine pre-compression cooling of a reserve gas turbine engine to reduce engine compression work.

(g) Another feature of the energy system in accordance with the present invention lies in providing capability for storage and transfer of liquefied air between buildings and vehicles.

(h) Another feature of the energy system in accordance with the present invention lies in providing ambient air intake for a reserve gas turbine engine when liquid air coolant is not available.

These aspects and features of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

FIG. 1 is a schematic illustration showing connection of components of a wind energy capture system with a reserve system for providing power to a building.

FIG. 2 is schematic illustration showing connections of components of a reserve engine system of the building of FIG. 1 in which solid lines joining components indicate fluid flow, arrows indicate flow direction, and dashed lines indicate electrical connection.

FIG. 3 is a cut away side view of a wind drive of the present invention mounted at the junction between a roof and a front wall of a structure.

FIG. 4 is a top view of the wind drive of FIG. 3.

FIG. 5 is a top view of building and fence structures to which a plurality of wind drives are mounted.

FIG. 6 is a front view of the building and fence structures of FIG. 5.

FIG. 7 is a schematic illustration showing connection of components of the preferred reserve engine-generator and transfer and storage system that form part of the building energy recovery, storage and supply system of the present invention in which solid lines joining components indicate fluid flow, arrows indicate flow direction, and dashed lines indicate electrical connection.

### DETAILED DESCRIPTION OF THE DRAWINGS

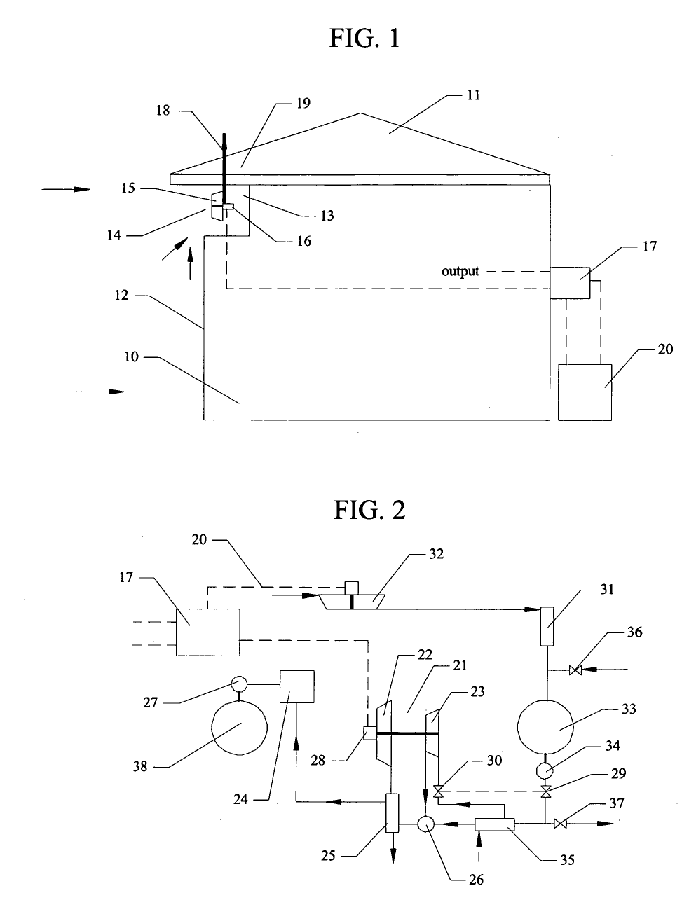

FIG. 1 illustrates one embodiment of the energy capture and reserve system of the present invention installed in a building 10 with a roof 11 and a windward corner 12 with a recess 13 containing a wind drive 14. Wind energy captured by a wind turbine 15 of drive 14 provides power from a main generator 16 to the building through a controller 17 while wind discharges through an outlet 18 to a wake region 19 of the roof. A reserve system 20 provides power to controller 17.

Wind energy capture works on the principle of parallel flow under equal pressure difference, with main flow over the building producing a smaller bypass flow through the wind turbine 15 and outlet 18. As shown in FIG. 1, outlet 18 is a circular duct that is disposed behind and in perpendicular relation with the wind turbine 15 in the wake region 19 of the roof. However, as described below, the outlet 18 may take any form provided it is disposed behind and in non-parallel relation with the wind turbine 15 in a wake region of the building. By disposing the outlet 18 in this manner, the lower pressure in the wake region 19 creates suction within the outlet, which augments the flow through the wind turbine 15.

Performance is evaluated for a representative building demand of 15 kWhr (20 hphr) per day for a two-story building with 186 m² (2000 ft2) floor area and 46 m² (500 ft2) frontal area. Demand for one day is met with wind capture by drive 14 at continuous upstream wind speed of 16 km/hr (10 mph), while estimated pressure difference of 6 m (20 ft) of air between wind impact pressure and wake region suction produces 15 kg/sec (33 lb/sec) of bypass flow through wind turbine 15 and outlet 18. Resulting outlet area is only 3.6% of building frontal area, substantially less than the maximum calculated area of 30% in accordance with the parallel flow relationship. Additional wind for energizing the reserve system or storing energy for export from the building can be captured by increased wind turbine and outlet area, and by taking advantage of above average wind energy, which is proportional to the third power of wind speed.

FIG. 2 illustrates a preferred embodiment of reserve system 20. A reserve engine 21 with a gas turbine 22, a compressor 23, a combustor 24, and a recuperator 25 receives air from a header 26 and fuel from a fuel pump 27 to drive a reserve generator 28 for providing power to controller 17. Air to the header is controlled by a pumped air valve 29 and a compressed air valve 30. An air liquefier 31 receives atmospheric air from a pressurizer 32 and discharges liquid air to a liquid air tank 33. The liquid air is pressurized by a liquid air pump 34 and vaporizes while cooling atmospheric air in an evaporator 35. Liquid air is transferred into tank 33 through a fill valve 36, transferred from tank 33 through a drain valve 37, and fuel is stored in a fuel tank 38.

Reserve system performance is evaluated to meet the 15 kWhr (20 hphr) per day demand for 4 days with no effective wind capture. During this period, fuel consumption is 18 kg (39 lb) and liquefied air consumption is 95 kg (209 lb). The liquefied air imported to tank 33 minimizes compression work by cooling of intake air to compressor 24, raising engine efficiency by over 300% as compared to a conventional inter-cooled and recuperated gas turbine. The need for imported liquefied air is reduced during periods of above average wind when liquefier 31 makes supplementary liquefied air, possibly including some for export. Liquefier operation during 6 hours of wind at 24 km/hr (15 mph) will provide enough liquefied air to meet daily demand. The quasi-isothermal pressurizer 32, drawing power from controller 17, provides inlet air to the liquefier 31. Liquefier 31 performance is based on target work input of 1395 kj/kg (600 btu/lb) at 3 mPa (30 atm); approximately 200% of the ideal reversible work input of 714 kj/kg (307 btu/lb) of liquefied air produced. Engine output is 12000 kJ/kg (5200 btu/lb) of fuel with an air-fuel ratio of 16, and gas turbine inlet temperature is 1500K (2700 R) at 3.0 mPa (30 atm). Methanol fuel is preferred because it is renewable, its oxygen content reduces liquefied air requirements, and production is enabled by low fuel demand in high efficiency gas turbines.

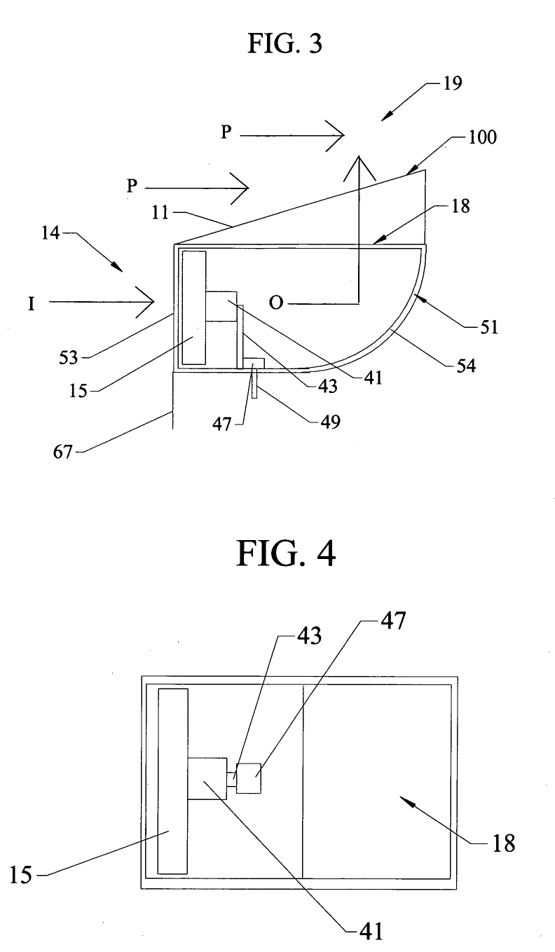

Referring now to FIGS. 3 and 4, a preferred embodiment of the wind drive 14 of the present invention is shown. Wind drive 14 includes a housing 51 having an open front portion 53 through which inlet airflow I may pass and a rear portion 54 that is preferably curved to direct outlet airflow O upward through outlet 18 and upward through an opening in the roof 11 of the building 100. Wind turbine 15 is disposed proximate to the front portion 53 of the housing 51 and is in mechanical communication with generator 41. Wind turbine 15 is preferably a wind flow turbine, but may be any art recognized device that will rotate when impinged upon by a flow of air. Generator 41 is preferably a coil and magnet type generator that converts the rotational mechanical energy from the wind turbine 15 into electricity. Support 43 is attached to the generator 41 and preferably includes wiring (not shown) that transfers the electrical energy from the generator 41 to an electrical junction box 47, from which electrical output 47 extends.

In operation, wind blowing in the direction of the wind drive 14 creates inlet airflow I and parallel airflow P about the roof 11 of the building 100. The parallel airflow P impacts the junction of the roof 11 and the front wall 67 of the building 100 and creates a wake region 19 in the area proximate to the junction of the roof 11 and the front wall 67 of the building 100, which is at a lower pressure than the pressure at the inlet portion 51 of the housing 53. The outlet 18 of the housing 51 is disposed within this wake region 19 in order to take advantage of this reduced pressure such that the outlet airflow O is more efficiently sucked up through the outlet 18.

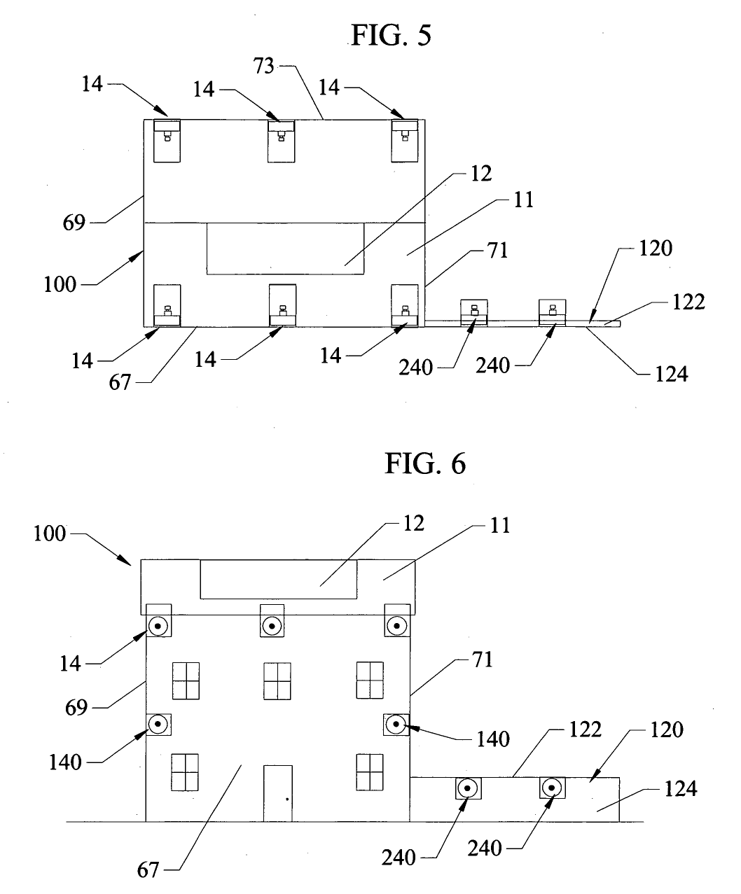

FIGS. 5 and 6 illustrate a preferred embodiment of the building energy recovery system 90 of the present invention. The building 100 includes a sloped roof 11 front wall 67, rear wall 73, and side walls 69, 71. A plurality of wind drives 14, such as those described with reference to FIGS. 3 and 4, are disposed along the junction between the roof 11, front wall 67 and rear wall 73. The number and location of these wind drives 14 in FIGS. 5 and 6 are for illustrative purpose only and, in locations where wind blows primarily in a single direction, such as along the seacoast, the wind drives 14 may only be disposed upon a single wall 67, 69, 71, or 73.

In addition to the wind drives 14 at the junction of the roof 11 and front and rear walls 67, 73, wind drives 140 are also mounted along the junction between front wall 67 and side walls 69, 71. These wind drives 140 are similar to those of FIGS. 3 and 4 except that the outlet (not shown) of each is disposed proximate to openings (not shown) in side walls 69, 71. Like the wind drives 14, the outlets of the wind drives are disposed within wake regions along side walls 69, 71.

In addition to the wind drives 14, 140 mounted to building 100, additional wind drives 240 are mounted to a fence 120 at the junction of the top 122 and front surface 124. These wind drives 240 are similar in all respects to the wind drives 14 mounted at the junction of the roof 11 and front and rear walls 67, 73 of the building except that their outlets 18 are mounted closer to the front surface 124 of the fence 120 due to the closer proximity of the wake region to the fence 120. It is noted that the mounting of wind drives 240 to a fence is for illustrative purposes and is meant to show that the wind drives 240 may be mounted to a variety of structures, provided they have junctions between surfaces that result in a wake region of reduced pressure.

The embodiment of FIGS. 5 and 6 also includes a photovoltaic panel 129 located on the roof 11 of the building. This photovoltaic panel 129 produces additional electricity. It is noted that all wind drives 14, 140, 240 and the photovoltaic panel 129 produce direct current electrical power, which is preferably used to power the energy storage and supply system 300 of the present invention.

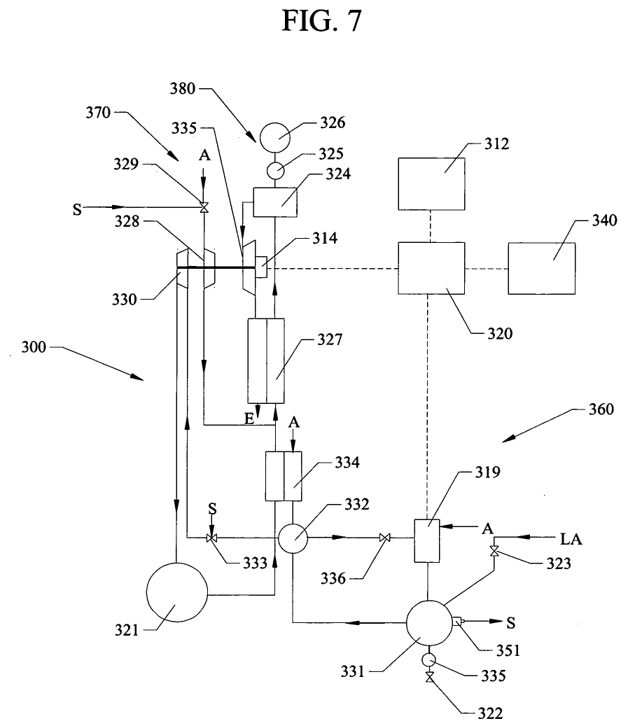

The preferred energy storage and supply system 300 of the present invention is shown in FIG. 7. The preferred energy storage and supply system 300 is made up of four sub-systems; the power conditioner 320, the liquid energy supply system 360, the atmospheric air supply system 370 and the combustion power generation system 380.

Electrical power from the solar panel(s) 312, wind drive(s) 340 and gas turbine 313 are supplied to a power conditioner 320, which combines the varying electrical power from the solar panel(s) 312, wind drive(s) 340, and gas turbine 313 into a stable power output. In some embodiments, power conditioner 320 includes a rheostat and an inverter, which converts the direct current electrical power into alternating current. In others it includes a deep cycle battery that accepts the various power inputs and provides a constant direct current output.

The power conditioner 320 provides power to the building and to the an air liquefier 319, which takes in atmospheric air A, liquefies the atmospheric air, and supplies liquid air to a liquid air storage tank 331. The preferred power conditioner 320 also includes a controller that has a signal input that accepts a signal S from a level gage 351 when the level of the liquid air drops below or above a predetermined level. The controller also preferably includes at least two outputs that send signals S to the liquid air supply valve 333 and the atmospheric air supply valve 329. These valves 333, 329 are preferably solenoid type valves that include a signal input that cause them to open or close based upon the receipt of a signal. When the level of the liquid air within the liquid air storage tank 331 falls below a predetermined low level, the controller sends a signal S to liquid air supply valve 333 instructing it to close and sends another signal S the atmospheric air supply valve 329 instructing to open. Thus, when liquid air levels are low, the combustor 324 is fed compressed air through the atmospheric air supply system 370. When liquid air levels return to an acceptable level, the controller sends another signal S to liquid air supply valve 333 instructing it to open and sends a signal S the atmospheric air supply valve 329 instructing to close, such that the combustor 324 is fed by the liquid air supply system 360.

Liquid air storage tank 331 is preferably a dewar, or other cryogenic tank, that maintains the liquid air in a liquid state. It is preferred that the liquid air storage tank 331 include a liquid air pump 335 and a drain valve 322 that allows liquid air LA to be drained from the liquid air storage tank 331 for use in other applications, such as vehicle operation, in which liquid air may be used. It is also preferred that the liquid air storage tank 331 include a fill valve 323 that allows liquid air LA to be added to the system from an external source (not shown)

Liquid air preferably flows from the liquid air storage tank 331 into mixing header 332, where it is mixed with atmospheric air A from chiller 334 to form vaporized liquid air. However, the mixing header 332 is eliminated in some embodiments and is replaced by an additional atmospheric air intake (not shown) that is preferably located at or proximate to liquid air compressor 330 and is used to mix with the liquid air and atmospheric air within the liquid air compressor 330. In embodiments utilizing the mixing header 332, a portion of vaporized liquid air can be recycled to the liquefier 319 via a reliquefier valve 336 for reliquefaction, while the remaining vaporized liquid air passes through a cryo-air valve 333 and upward into liquid air compressor 330.

Liquid air compressor 330 is preferably attached to the gas turbine 328 via a shaft 339, which provides the motive force for the compressor 330. However, in some embodiments it is an electrically powered compressor. Liquid air compressor 330 acts to heat and compress a mixture of liquid air and atmospheric air such that the liquid air changes phase and the mixture of liquid air and atmospheric air turns into compressed air. This compressed air then flows into compressed air tank 321.

Compressed air from the compressed air tank 321 flows upward through the chiller 334, which is a cross flow heat exchanger that allows heat from the atmospheric air to be transferred to the compressed air. The compressed air then flows upward through recuperator 327, which is also a cross flow heat exchanger that allows heat from the exhaust gasses from the gas turbine 313 to be transferred to the compressed air. The heated compressed air then passes into combustor 324, where it serves as combustion air for the fuel pumped by fuel pump 325 from fuel tank 326. Combustion gasses then pass from combustor 324 into gas turbine 313, causing gas turbine 313 to rotate. This rotation acts to rotate shaft 339, which provides motive power to the liquid air compressor 330 and atmospheric air compressor 328. In addition, it rotates a rotor within generator 314, which coverts the rotational energy into electrical energy that is fed back to the power conditioner 320 through an electrical output.

As explained above, the preferred energy storage and supply system 300 of the present invention also includes an atmospheric air supply system made up of atmospheric air valve 329 and atmospheric air compressor 328. The atmospheric air compressor 328 takes atmospheric air through the atmospheric air valve 329 and passes it through the recuperator 327 and into the combustor 324 when the liquid air storage tank 321 is low.

In the example case, gas turbine inlet temperature is 1160 K (2100° R.) and pressure ratio is 0.5 mPa (5 atm), which is compatible with commercially available micro-turbine engines in the appropriate size range. Relatively constant load is maintained during both daytime and overnight modes of operation by driving an air liquefier during periods of reduced electrical demand. The gas turbine also enables a wide selection of fuels. Daytime engine operation is in a Brayton cycle modified by addition of liquid air injection with the ambient air valve closed and the cryo-air valve open. Atmospheric intake air is cooled at nearly constant pressure to the cryo-compressor inlet, first in the chiller and then by a mixture of compressed atmospheric air and vaporized liquid air from the liquid air pump. The pressurized mixture continues above ambient temperature, absorbing exhaust heat in the high pressure side of the recuperator and heat of combustion in the combustor, followed by expansion in the gas turbine and cooling of exhaust in the low pressure side of the recuperator. Fuel consumption is 1.3 kg (2.9 lb) based on a lower heating value of 42000 kJ/kg (18000 Btu/lb) and liquid air consumption is 33 kg (73 lb). The working fluid cools gas turbine exhaust to ambient because cryo-compression heating is at below ambient temperature. Overnight engine operation is in a conventional Brayton cycle with the ambient air valve open and the cryo-air valve closed while driving the air liquefier. The engine-generator provides 60% of required liquid air while coincident operation of the wind generator provides 40%. Fuel consumption is 1.5 kg (3.4 lb) based on a lower heating value of 42000 kJ/kg (18000 Btu/lb). Liquefier performance is based on a figure of merit of 0.5, defined as; ideal reversible work input of 714 kj/kg (307 btu/lb) of liquid yield divided by estimated real work input of 1428 kj/kg (614 btu/lb) of liquid yield.

Example performance for the preferred system is presented for the two-story building with 223 m² (2400 ft²) plan area and 66 m² (720 ft²) front area. Average energy demand of the building is 30 kWhr (40 hphr) during a 16-hour daytime operating mode, with no overnight use. Combined wind generator and engine generator in an 8-hour nighttime operating mode drives the air liquefier. Worst case solar and wind conditions are based on data for Seattle, Wash. during December; mean solar insulation is 2724 kJ/daym² (240 Btu/dayft²) and mean wind speed is 16 km/hr (10 mph). Solar recovery is by 56 m² (600 ft²) of panel area with a conversion efficiency of 20% and solar generation meets 28% of building demand. As explained above, wind recovery works by airflow over windward building edges, suctioning a smaller flow through a series of appropriately spaced wind turbines. Estimated wind turbine conditions are; optimum on-center spacing of four turbine diameters, suction of four velocity heads, turbine impact velocity of 1.2 times mean wind speed and 90% generator efficiency. Under these conditions wind generation meets 32% of building electrical demand during daytime (16 hours) and drives the air liquefier overnight (8 hours) to produce a portion of liquid air required for daytime engine compression and pre-compression cooling. High efficiency (80%) engine daytime operation (6.5 hrs) with compression and pre-compression cooling provides the remaining 40% of demand, while relatively constant load operation is maintained. Moderate efficiency (40%) overnight engine operation (8 hr), with ambient air compression, drives the liquefier to replenish the liquid air storage tank. Import or export of liquid air is not required.

Low fuel consumption results in proportionately low emissions and also helps to enable local production of bio-fuels. Engine efficiency is relatively constant over the load range and energy storage with liquid air is approximately eight times as compared to lead acid batteries.

Although the description above contains many specifics, these should not be construed as limiting the scope of the invention, but only to provide illustrations of some of the preferred embodiments of this invention. For example, the energy recovery and reserve system of the present invention can use any suitable fuel, available heat source or working fluid. Wind, solar and liquefied gas can be used in any combination to enable mechanical or electrical Drive of working fluid compressors and gas liquefiers. Features such as quasi-isothermal expansion or reheating, or quasi-isothermal compression or inter-cooling, of the working fluid can enhance engine performance. Engine emissions can be improved by features such as separation of carbon dioxide from combustion products and support of combustion by oxygen enriched air. Any suitable fluid can enhance engine combustion cooling. Finally, wind recovery can be enhanced in various ways including building orientation to the wind and arrangement of adjacent structures. Accordingly, the scope of the invention should be determined by the appended claims and their legal equivalents, rather than the examples given.

What is claimed is:

1. A building comprising:
a building structure comprising at least a front wall and a roof forming a roof junction with said front wall; and
an energy recovery system comprising at least one wind drive mounted to said building structure proximate to said roof junction between said roof and said front wall, said at least one wind drive comprising a housing comprising an open front portion and a rear portion, a wind turbine disposed proximate to said front portion of said housing in substantially parallel relation to said front wall, a generator in mechanical communication with said wind turbine, an electrical output in electrical communication with said generator, and an outlet disposed behind said wind turbine and said generator and in non-parallel relation to said wind turbine;
wherein said roof comprises an opening therethrough, wherein said outlet of said wind drive is in communication with said opening, and wherein said opening and said outlet are disposed within a wake region behind said roof junction.

2. The building as claimed in claim 1 further comprising a side wall forming a wall junction with said front wall, wherein at least one of said at least one wind drive is mounted to said building structure proximate to said roof junction between said roof and said front wall and said wall junction between said front wall and said side wall.

3. The building as claimed in claim 1 further comprising a side wall forming a wall junction, wherein said at least one wind drive comprises at least one roof wind drive and at least one wall wind drive, wherein at least one of said at least one roof wind drive is mounted to said building structure proximate to said roof junction between said roof and said front wall and said wall junction between said front wall and said side wall, and wherein said at least one wall wind drive is mounted to said building structure proximate to said wall junction between said front wall and said side wall.

4. The building as claimed in claim 1 wherein said outlet of said wind drive comprises a substantially circular duct.

5. The building as claimed in claim 1 further comprising a second structure proximate to said building, wherein said second structure comprises at least two surfaces and a junction between said at least two surfaces, and wherein said energy recovery system further comprises at least one wind drive mounted to said second structure proximate to said junction between two of said at least two surfaces.

6. The building as claimed in claim 1 wherein said energy recovery system further comprises at least one photovoltaic panel disposed upon said roof of said building.

7. The building as claimed in claim 1 further comprising an energy storage and supply system comprising:
at least one compressor in fluid communication with at least one source of air;
a combustor in fluid communication with said at least one compressor;
a source of fuel in fluid communication with said combustor;
a gas turbine in fluid communication with said combustor and in mechanical communication with a rotatable shaft; and
a turbine generator in mechanical communication with, and driven by, said rotatable shaft, said turbine generator comprising an electrical output.

8. The building as claimed in claim 7 further comprising a power conditioner in electrical communication with said electrical output of said wind drive and said electrical output of said turbine generator.

9. The building as claimed in claim 8 further comprising:
an air liquefier in electrical communication with said power conditioner and in fluid communication with a source of atmospheric air;
a liquid air storage tank in fluid communication with said liquefier and said at least one compressor; and
a compressed air storage tank disposed between and in fluid communication with one of said at least one compressor and said combustor.

10. The building as claimed in claim 9, wherein said gas turbine further comprises an exhaust and wherein said energy storage and supply system further comprises:
a mixing header in communication with said liquid air storage tank and said at least one compressor;
a chiller in fluid communication with said compressed air storage tank and said source of atmospheric air for said mixing header; and
a recuperator in fluid communication with said chiller and said exhaust of said gas turbine;
wherein said chiller is disposed between said compressed air storage tank and said recuperator and wherein said recuperator is disposed between said chiller and said combustor.

11. The building as claimed in claim 7 wherein said at least one compressor comprises an atmospheric air compressor in fluid communication with a source of atmospheric air and a liquid air compressor in fluid communication with a source of liquid air.

12. The building as claimed in claim 11 wherein at least one of said atmospheric air compressor and said liquid air compressor is in mechanical communication with, and driven by, said rotatable shaft.

13. The building as claimed in claim 11 further comprising an atmospheric air supply valve in fluid communication with said atmospheric air compressor and a liquid air supply valve in fluid communication with said liquid air compressor;
wherein said power conditioner comprises a controller having a signal input and at least two signal outputs;
wherein said liquid air storage tank further comprises a level gage comprising a signal output in electrical communication with said signal input of said controller;
wherein said atmospheric air supply valve comprises a signal input in electrical communication with one of said at least two signal outputs of said controller of said power conditioner;
wherein said liquid air supply valve comprises a signal input in electrical communication with one of said at least two signal outputs of said controller of said power conditioner; and
wherein said controller of said power conditioner comprises control means for accepting a low level signal from said level gage through said signal input, sending a signal to said liquid air supply valve instructing said liquid air supply valve to close, and sending a signal to said atmospheric air supply valve instructing said atmospheric air supply valve to open.

14. The building as claimed in claim 7 wherein at least one of said at least one compressor is in mechanical communication with, and driven by, said rotatable shaft.

15. The building as claimed in claim 8 wherein said energy recovery system further comprises at least one photovoltaic panel disposed upon said roof of said building, said photovoltaic panel comprising an electrical output, and wherein said electrical output of said at least one photovoltaic panel is in electrical communication with said power conditioner.

16. The building as claimed in claim 9 further comprising a liquid air inlet, a liquid air pump and a liquid air drain valve in fluid communication with said liquid air storage tank.

17. A building comprising:
a building structure comprising a roof, a front wall, and a side wall, wherein said roof and said front wall abut to form a roof junction and wherein said side wall and said front wall abut to form a wall junction; and
an energy recovery system comprising at least one wind drive mounted to said building structure proximate to at least one of said roof junction and said wall junction, said at least one wind drive comprising a housing comprising an open front portion and a rear portion, a wind turbine disposed proximate to said front portion of said housing in substantially parallel relation to said front wall, a generator in mechanical communication with said wind turbine, an electrical output in electrical communication with said generator, and an outlet disposed behind said wind turbine and said generator and in non-parallel relation to said wind turbine;
wherein at least one of said roof and said side wall comprises an opening therethrough, wherein said outlet of said wind drive is in communication with said opening, and wherein said opening and said outlet are disposed within a wake region behind said at least one of said wall junction and said roof junction.

18. The building as claimed in claim 17 further comprising energy storage and supply system comprising:
at least one compressor in fluid communication with at least one source of air;
a combustor in fluid communication with said at least one compressor;
a source of fuel in fluid communication with said combustor;
a gas turbine in fluid communication with said combustor and in mechanical communication with a rotatable shaft; and
a turbine generator in mechanical communication with, and driven by, said rotatable shaft, said turbine generator comprising an electrical output.

19. The building as claimed in claim 18 further comprising:
a power conditioner in electrical communication with said electrical output of said wind drive and said electrical output of said turbine generator;
an air liquefier in electrical communication with said power conditioner and in fluid communication with a source of atmospheric air;
a liquid air storage tank in fluid communication with said liquefier;
a mixing header in fluid communication with said liquid air storage tank, a source of atmospheric air, and one of said at least one compressor; and
a compressed air storage tank disposed between and in fluid communication with one of said at least one compressor and said combustor.

20. A building comprising:
an energy recovery system comprising at least one of a wind drive having an electrical output and a photovoltaic panel having an electrical output; and
an energy storage and supply system comprising;
a power conditioner in electrical communication with said electrical output of at least one of said wind drive and said photovoltaic panel, wherein said power conditioner comprises a controller having a signal input and at least two signal outputs;
a liquid air supply system comprising;
an air liquefier in electrical communication with said power conditioner and in fluid communication with a source of atmospheric air;
a liquid air storage tank in fluid communication with said liquefier, said liquid air storage tank comprising a level gage having a signal output in electrical communication with said signal input of said controller of said power conditioner;
a liquid air supply valve in fluid communication with said liquid air storage tank, said liquid air supply valve comprising a signal input and in electrical communication with one of said at least two signal outputs of said controller of said power conditioner;
a liquid air compressor in fluid communication with liquid air supply valve; and
a compressed air storage tank in fluid communication with said at least one compressor;
an atmospheric air system comprising;
an atmospheric air supply valve in fluid communication with a source of atmospheric air, said atmospheric air supply valve comprising a signal input in electrical communication with one of said at least two signal outputs of said controller of said power conditioner; and
an atmospheric air compressor in fluid communication with said atmospheric air supply valve; and
a combustion power generation system comprising;
a combustor in fluid communication with said compressed air storage tank and said atmospheric air compressor;
a source of fuel in fluid communication with said combustor;
a gas turbine in fluid communication with said combustor and in mechanical communication with a rotatable shaft; and
a turbine generator in mechanical communication with, and driven by, said rotatable shaft, said turbine generator comprising an electrical output;
wherein said controller of said power conditioner comprises control means for accepting a low level signal from said level gage through said signal input, sending a signal to said liquid air supply valve instructing said liquid air supply valve to close, and sending a signal to said atmospheric air supply valve instructing said atmospheric air supply valve to open.
